(19) United States
(12) Patent Application Publication
(10) Pub. No.: US 2006/0082850 A1
(43) Pub. Date: Apr. 20, 2006

(54) Covert surface relief hologram design, fabrication and optical reconstruction for security applications

(76) Inventors: Samuel P. Weaver, Boulder, CO (US); Robert McLeod, Boulder, CO (US); Kevin R. Curtis, Longmont, CO (US); Adrian J. Hill, Lyons, CO (US)

Correspondence Address: WENDEROTH, LIND & PONACK, L.L.P., 2033 K STREET N. W., SUITE 800, WASHINGTON, DC, 20006-1021, US

(21) Appl. No.: 10/965,867

(22) Filed: Oct. 18, 2004

(51) Int. Cl. G03H 1/00

(52) U.S. Cl. 359/2; 283/86

(57) ABSTRACT

Disclosed is an article having a surface-relief holographic recording medium having digital data that cannot be seen by human eye. Also disclosed is a tilted-plane optical reader system which can be used to read the stored data in the hologram.

### TECHNICAL FIELD

The present invention relates to storage of data in holographic media. In particular, the present invention relates to storage of covert holographic data in an article having a holographic recording medium.

### BACKGROUND

Holography is a familiar technology for displaying three dimensional images. Basically, two coherent light beams are caused to intersect in a holographic medium. An interference pattern or grating pattern results that is unique to the two beams and which is written into the medium. This grating pattern is referred to as the hologram and has the property that if it is illuminated by either of the beams used for recording, the illuminating beam diffracts in the direction of the second writing beam. To an observer, it appears as if the source of the second beam is still present at an observation plane.

There are two significant types of holograms to consider: surface relief holograms and volume holograms. Surface relief holograms act on an incident optical wavefront by imparting a local phase shift which is proportional to the holographic material height at a specific location. In a surface relief hologram, local optical path length is proportional to the physical path length at a specific location. Volume holograms act on an incident optical wavefront by imparting a local phase shift which is proportional to the index of refraction of the holographic material at a specific location. In a volume hologram, local optical path length is proportional to the index of refraction at a specific location, while the physical path length does not vary in the holographic material.

Holograms are becoming more common for use in other types of applications such as security and data storage. In data storage applications, as is well understood by those skilled in the art, a page of data is used as a source image and a detector array is placed at the observation plane. A complete discussion of storage holograms can be found, for example, in John R. Vacca, Holograms & Holography Design, Techniques, & Commercial Applications, Charles River Media, Inc., 2001 (“Vacca”). Generally, data stored in holographic media is only machine readable.

With respect to security applications, it is well known to include holograms on credit cards to prevent duplication of these items. A hologram is useful in this context because of the relative difficulty involved in counterfeiting a hologram as compared to printed designs, embossed features and even photographs. However, security holograms used on credit cards are generally embossed only on the surface of the card, As such, while holograms in general are relatively difficult to duplicate, a hologram on the surface of a card can be somewhat easier to duplicate or alter.

One potential solution to the problems associated with relative ease of duplication of surface holograms is offered in U.S. Pat. No. 6,005,691 for “High-Security Machine-Readable Holographic Card” to Grot et al. Grot et al. discloses a hologram card which includes a first plastic material formed to include localized topological features constituting a diffractive optical element. The diffractive optical element is structured to generate a hologram image. The hologram card also includes a protective layer which is chemically bonded to and directly contacts the topological features constituting the diffractive optical element. While the hologram card of Grot et al. includes a protective layer to make any hologram included in the diffractive element more difficult to duplicate, the card includes only a surface hologram, which holds a relatively small amount of information. That is, the hologram card disclosed in Grot et al. is relatively inefficient.

Additionally, while credit cards, and drivers licenses and identification cards, can typically store some information in a magnetic stripe often included with such cards, the amount of information such magnetic stripes can store can be relatively low.

Holographic labels, seals, and markers of all appearances and types are increasingly being used for security applications in diverse areas of activity such as credit card identification, document authentication, currency security, branding of commodities, unique marking of software and pharmaceuticals, and numerous other applications. Within the class of holographic appliqués, the machine-embossed foils most frequently used are called diffractive optically variable image devices (DOVIDs, OVIDs, OVDs). These devices are affixed permanently or semi-permanently to the devices or commodities that they mark, and their bright, three-dimensional appearances attract attention and identify the commodity as genuine. As might be expected, unscrupulous dealers of counterfeit products attempt to replicate these holographic markers to make their products appear genuine. In response, the manufacturers of these holograms have implemented approaches such as hidden or latent images embedded in the visible hologram that can be viewed only with a specialized optical reader. Another feature becoming widely employed within these holograms is machine-readable product identification markings, such as embedded UPC bar codes. Both optical and electron-beam mastering techniques are used to produce these modern holographic foils which multiplex visible images with machine-readable data within a single embossed foil patch.

### SUMMARY OF THE INVENTION

An embodiment of this invention is an article comprising a surface relief holographic recording medium comprising digital data formatted in a two-dimensional page format and recorded with a holographic fringe period that is sufficiently small such that the diffracted light from the digital data cannot be seen by human eye. The holographic recording medium is a holographic material that is suitable for recording surface relief holograms only. Preferably, the surface relief holograms are constructed using modulation fringes which only diffract light that cannot be seen by human eye. Preferably, the holographic material that records surface relief holograms is a foil. Preferably, the digital data can only be reconstructed using ultraviolet light. Preferably, the digital data is written using modulation fringes which require reconstruction using tilted-plane imaging.

A further embodiment of the article comprises a visible image in the holographic recording medium. Preferably, the visible image is a hologram that diffracts light that is both visible and invisible to human eye. Preferably, the article comprises a patch capable of being attached to a document, a card, a banknote or merchandise. Preferably, the article further comprises a transparent protective layer overlaying the holographic recording medium. Preferably, the digital data is machine readable holographic data. Preferably, the holographic recording medium has multiple data sections for storing the digital data and other information. Preferably, the other information is visible to human eye.

Yet a further embodiment of the article further comprises a substrate layer and a laminating layer overlaying a protective layer. Preferably, the digital data includes spatially multiplexed holographic data.

Preferably, the digital data is multiplexed in substantially a same location as that of an image hologram visible to human eye. Preferably, the digital data is patterned as a two-dimensional array of data bits. Preferably, the digital data is a full page of digital data. Preferably, the digital data is patterned as a series of digital data that is read by a scanner, More preferably, the digital data are holographically encoded using phase, or amplitude, or both such that an encoded readout beam is required to be able to read the digital data. Preferably, the digital data are recorded and read by UV light.

A further embodiment of the article comprises modulation marks for timing and/or positional servo. Preferably, the digital data is written into the holographic recording medium before assembling components of the article Into the article. Preferably, the article is a document, a card, merchandise or a banknote.

One embodiment is a method of authentication of an article comprising a holographic recording medium comprising digital data that cannot be seen by human eye, the method comprising obtaining the article and reading a hologram on the article by a tilted-plane imaging system. Preferably, in the tilted plane imaging system an input image and an output image are tilted to the optical axis of the tilted plane imaging system. Preferably, the input image and the output image are substantially distortion-free and a readout beam of the input image is substantially parallel to a data diffraction beam of the output image. Preferably, the tilted plane imaging system further produces a specular reflection beam of the output image that is at an angle in the range of about 20 to about 160 degrees with respect to the data diffraction beam. In one variation, the tilted plane imaging system produces a logo diffraction beam of a logo on the article.

Preferably, the reconstructed beam of a two-dimensional image is passed through an intervening optical system that is a spherical afocal telescopic system comprising a multiplicity of optical elements. Preferably, the intervening optical system is an afocal telescopic system comprising two spherical optical lens groups, positioned physically to bring the focal positions of the two spherical optical lens groups into coincidence. In one variation, a cylindrical imaging telescope is employed with an orthogonally-oriented single cylindrical lens for improved light efficiency. In one variation, a combination of cylindrical and spherical imaging optical elements is employed. Preferably, the holographic recording medium is a holographic material that records surface relief holograms. Preferably, the digital data is Written using modulation fringes which require reconstruction using tilted-plane imaging.

### BRIEF DESCRIPTION OF THE DRAWINGS

FIG. 1: Tilted-plane reader system for invisible data holograms with spherical optics and a 2D parallel output. This format is for two-dimensional pagewise digital data.

FIG. 2: Tilted-plane reader system for invisible data holograms with spherical optics and a 1D linear output. This format is for two-dimensional barcode digital data.

FIG. 3: Reader system for invisible data holograms with spherical and cylindrical optics and a 1D linear output. This format is for two-dimensional barcode digital data and could be light-efficient.

FIG. 4: Tilted-plane reader system for invisible data holograms with spherical optics and a 2D parallel output. This format is for two-dimensional pagewise digital data. This system employs an optical phase element to reconstruct a data hologram whose fringe patterns have been encrypted with optical phase to make them more difficult to reconstruct.

FIG. 5: Tilted-plane reader system for invisible data holograms with spherical optics and a 1D linear output. This format is for two-dimensional barcode digital data. This system employs an optical phase element to reconstruct a data hologram whose fringe patterns have been encrypted with optical phase to make them more difficult to reconstruct.

FIG. 6: Reader system for invisible data holograms with spherical and cylindrical optics and a 1D linear output. This format is for two-dimensional barcode digital data and could be light-efficient, This system employs an optical phase element to reconstruct a data hologram whose fringe patterns have been encrypted with optical phase to make them more difficult to reconstruct.

FIG. 7: A Zemax model of a single-lens imaging system used in a parallel plane hologram geometry.

FIG. 8: Input object and output image for single-lens imaging of conventional hologram demonstrating good imaging performance. Notice that the output grid is not distorted.

FIG. 9: A single-lens imaging system applied to the high-covertness foil image plane, in this case tilted at a 35 degree angle from the normal.

FIG. 10: Object plane and processed image plane illustrating distortion of tilted planes by single-lens imaging system. Notice that the output grid is distorted.

FIG. 11; A two-lens telescope applied to the parallel plane geometry, with parallel object and image planes.

FIG. 12: Object and distortion-free image planes of conventional hologram in two-lens system. Notice that the output grid is not distorted.

FIG. 13: The input object and output image planes of the high-covertness data hologram, in this case imaged without position-dependent magnification.

FIG. 14: Object and distortion-free image planes of high-covertness hologram in two-lens system. Notice that the output grid is not distorted.

FIG. 15: Optical system layout of laboratory test system used to validate performance of conventional and high-covertness foils. This system imaged test foils in both conventional and high-covertness geometries, using both 1D and 2D data formats.

### DETAILED DESCRIPTION

An embodiment of this invention relates to an article comprising a surface relief holographic recording medium comprising digital data contained within the surface relief holographic recording medium that cannot be seen by human eye.

A preferred article in accordance with the present invention includes a multi-layer holographic structure such as a card, a patch, or appliqué having sections for containing holographic machine readable data as well as for containing security and/or presentation information which may be either machine or human readable and may also be holographic. The article of this invention is preferably constructed of multiple layers and preferably includes at least a data layer and a protective layer overlaying the data layer. By including the protective layer, information placed in the data layer can not be altered without removing the protective layer, thereby destroying the article of this invention. In this way, information placed in the data layer is advantageously more secure than if the protective layer was not provided. Multiplexed digital image patterns can be used to store information that is relatively difficult to replicate. This can advantageously make such an article of this invention relatively difficult to counterfeit.

The article of this invention could be small (e.g. stamp sized) or large (e.g. book size). Additionally, while article of this invention is in the form of a rectangle, a holographic article of this invention in accordance with the present invention can be any shape including, without limitation, a square, circle, triangle or toroid. Deterring counterfeiting would be important for applications such as drivers' licenses, credit cards, ID cards, or content distribution.

Digital data is preferably contained in a surface relief hologram layer. Additional holographic data can include, without limitation, images of the user; fingerprint, voice or other user biometric data; and/or holographic patterns to make the article difficult to copy. In addition, the article could have presentation data in a presentation/security section of the article. The presentation data can include, without limitation, a company name, company logo, user name, and user contact information. Some or all of this information can also be included in a holographic material layer in non-holographic form. For example, without limitation, a company logo or user contact information could be included in non-holographic form while other presentation/security information could be included in holographic form.

A method of making a holographic multi-layer structure having multiple layers in accordance with the present invention is disclosed in U.S. Pat. No. 5,932,045 which is hereby incorporated by reference herein in its entirety.

It is possible for the adherent to be photocurable or otherwise curable, e.g., radiation or chemical curable. Heat may be used to accelerate a radiation cure. When using the above method, it is preferable for the adherent to be a material that undergoes a phase transformation, e.g., liquid to solid, to attain a desired adherence. As used herein, the terms cure and curable are intended to encompass materials that gel or solidify by any such methods. Photocurable adherents include materials that cure upon exposure to any of a variety of wavelengths, including visible light, UV light, and x-rays. It is also possible to use adherents that are curable by electron or particle beams.

Protective layer and substrate layer of the article of this invention can be fabricated from either the same or different materials. The materials from which protective layer and substrate layer can be formed include, without limitation, ceramics (including glasses), silicon, metals, polycarbonate, polymethylmethacrylate, or acrylic, or plastics In addition to self supporting substrates such as glass plates, it is possible for the substrate to be a polymeric material that is sprayed onto a holder, a thin polymer film such as Mylar®, or a polymer sheet such as polycarbonate. It is also considered that a polymeric material or film be combined with a self supporting material such as a glass plate to form a single substrate. Either or both protective layer and substrate layer may be an optical article such as, with limitation, a polarizer, half or quarter wave plate, neutral density filter, birefrengement plate, or diffractive optic.

The article could also have a laminating layer that is preferably transparent and can be made from the same material as the protective layer discussed above. The article could have a non-holographic layer that can be fabricated from any suitable material depending upon the nature of the non-holographic data contained therein. For example, without limitation, if the non-holographic layer could be a photograph, the fabrication material would be a photographic or printed paper or emulsion. If non-holographic layer is text data or a printed symbol, the fabrication material could be printed paper or plastic.

The card, patch, merchandise or banknote shaped article of the preferred embodiment can be manufactured in substantially the same way as the article of this invention discussed above. In particular, substrate layer, holographic media layer and protective layer can be laminated. Then, a non-holographic layer can be placed on or in protective layer as is well understood by those skilled in the art and a laminating layer can be placed thereover, as is also well understood by those skilled in the art.

In order to produce a holographic security foil, a visible image and/or a concealed (latent) image and/or a data pattern are designed. If optical methods are used to construct initial holographic master, then masks or models of each constituent portion of the final hologram are constructed, and an optical hologram is exposed which combines all of the desired imagery in a single holographic master. This master is composed of surface relief structures called fringe patterns that reconstruct the desired images upon illumination with light of the appropriate properties. If a direct fringe writing approach (such as an electron beam machine) is to be used to create the initial holographic masters, a fringe pattern is calculated for each of the constituent images, and these patterns are combined with an appropriate algorithm and used to drive the writing apparatus. The resulting master is similarly composed of surface relief structures called fringe patterns that reconstruct the desired images upon illumination with light of the appropriate properties, though the fringe patterns produced with the direct-writing approach will usually have different characteristics than those produced with an optical approach Using the direct fringe writing approach, a common technique for spatially multiplexing multiple holographic images in substantially the same location is called interlacing. This technique is realized by dividing up the holographic area into sections substantially smaller than the overall hologram area, and then constructing fringe patterns for each data or display hologram which occupy only a portion of the sections.

One embodiment of this invention relates to a particular design approach for security holograms that enables data and images to be stored which are entirely invisible when viewed by the human eye. These highly covert data and images can be imbedded within a visible holographic image, and can be multiplexed with any other security hologram data storage or imaging approach employed currently. A particular class of optical reader system could be used to reconstruct holograms that are fabricated using this invention. This invention also relates to the application and reduction to practice of an optical reader system for reconstructing highly covert holographic data in security holograms.

To combine the covert data with a visible image can be desirable to hide the data more effectively. This can be accomplished during the mastering process by interlacing the fringes of the security hologram with the fringes for the visible hologram using a tiling interleaving which has a higher spatial sampling than the data sampling. This type of interlacing is well understood by those skilled in the art of surface relief hologram design.

One embodiment of the method described in this invention is the construction of a covert currency security hologram composed of fringe patterns of a spatial frequency high enough that electromagnetic radiation (light) with a wavelength longer than a particular design value is not diffracted from those fringes, while electromagnetic radiation with a wavelength shorter than the design value is diffracted from these fringes. In the preferred embodiment, the security hologram comprises fringe patterns of a spatial frequency high enough that visible light is not diffracted from those fringes, while light in another region of the electromagnetic spectrum is diffracted from these fringes, producing a situation in which the light that is diffracted from the covert security hologram is invisible to the human eye. In the preferred embodiment, the fringe patterns constituting the covert hologram are multiplexed with the fringe patterns constituting a visible image hologram, such that a visible image is apparent to a human viewer, while the covert security hologram is invisible to a human viewer. In the preferred embodiment, the fringe pattern constituting the covert hologram comprises a spatial frequency that diffracts light from the ultraviolet band of the electromagnetic spectrum, while not diffracting light from the visible band of the spectrum. The spatial frequency preferred for achieving the preferred embodiment is >5000 lines/mm, In further embodiments, the light diffracted from the security hologram is in other regions of the electromagnetic spectrum that are invisible to the human eye. In one embodiment, the hologram(s) are written using surface relief structures on a thermoplastic foil medium. In other embodiments, the holograms are written in any material that can physically reproduce the desired holographic fringe patterns. In the preferred embodiment, a data pattern having a modulation of the fringe pattern is encoded into the covert security hologram in the fabrication process, and the data pattern is imposed on the diffracted light produced when the hologram is illuminated with light from the region of the spectrum for which the fringe pattern was designed.

The use of the optical reading system described in this invention for writing security holograms is similar to those contemplated for holographic data storage. The combination of designing the security hologram fringe spacing to diffract only invisible light and to require a tilted-plane imaging system to reconstruct the data is novel. The systems shown below use transmissive elements to image but reflective imaging systems are equally suitable.

The data to be stored can be arranged for readout in a line, a bit by bit, bit by bit but parallel independent streams, bar code, or pagewise. Examples include: storing the data in a fashion similar to CD or DVD bit patterns holographically, reading out a line of bar codes in parallel with a line detector, or a 2D data pattern readout out in parallel by imaging or line by line by using a line detector and moving the hologram in with respect to the optical system. The data would have error correction, channel modulation and timing/servo marks recording into the hologram with the data.

For any of the data arrangements, a physical encoding approach can be employed to further complicate the reconstruction of the holographically stored data. The encoding method consists of designing an optical phase distribution which is superposed with the data fringe pattern, and which is intended to be reversed during the data reconstruction process. When this method is employed to encode the data hologram, the reader system must employ an optical phase element in the reconstruction path whose phase distribution reverses the phase distribution that was initially superposed with the data hologram, resulting improper reconstruction of the data pattern. An optical system which does not successfully reverse this physical phase encoding will not be able to reconstruct the encoded data pattern.

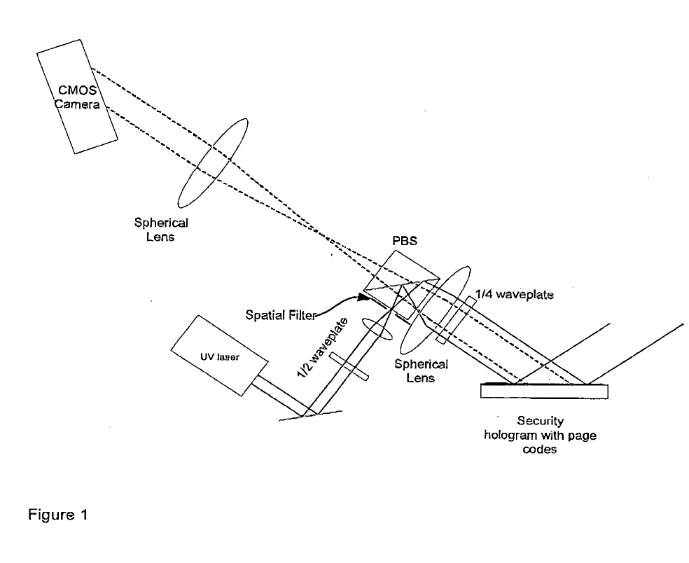

One embodiment of a tilted-plane reader system for invisible data holograms is shown in FIG. 1, which shows a reader system with spherical optics and a 2D output. The preferred embodiment for this reader system employs UV light to accomplish the readout of the hologram whose fringes have been designed to diffract only these wavelengths. This approach requires stopping (or slowing) the hologram briefly to capture a 2D image on the output camera. If magnification is desired for pixel-matching between the input and output planes, the telescope approach will be able to implement that requirement. The 2D output approach will probably have tighter rotational requirements on the detector array (camera) than would be the case using a linear array. The system layout which is illustrated employs collinear reference beam illumination and diffracted data beam reconstruction, which is a layout which minimizes the required optical elements. The reference beam illumination path can also be separated from the data beam reconstruction path, which may be desired for system considerations.

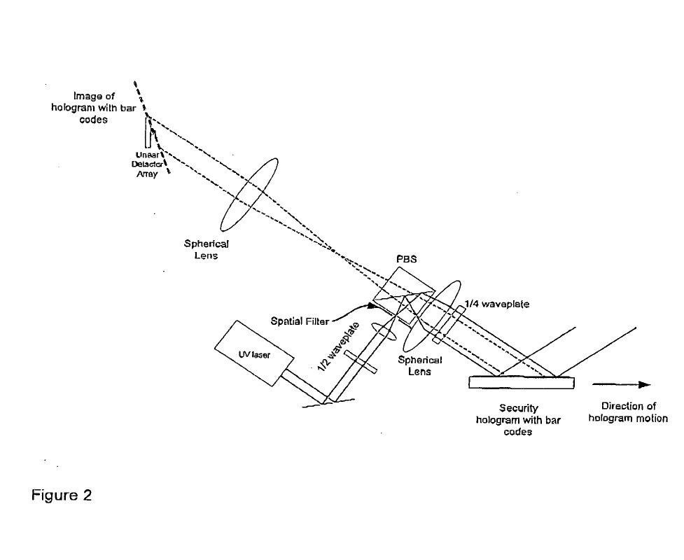

A second embodiment of a tilted-plane reader system for invisible data holograms is shown in FIG. 2, which shows a reader system with spherical optics and a 1D linear output. Because of the one-dimensional line focus on the output detector array, this configuration does not have to be oriented as critically as the data page system in order to achieve focused operation upon reconstruction. The preferred embodiment for this reader system employs UV light to accomplish the readout of the hologram whose fringes have been designed to diffract only these wavelengths. In FIG. 2, the tilted image plane of the reconstructed data image is illustrated, and the linear detector will sample the bar codes as they move past. This approach requires continuous or stepped motion of the input hologram past the center of the illuminating beam. If magnification is desired for pixel-matching between the input and output planes, the telescope approach will be able to implement that requirement. This approach is not as light efficient as using a line focus to illuminate the hologram, but with the correct sizing of the collimated beam, it could be acceptable. The hologram might be pressed against a roller to make it flat as it is moved through the reader. The system layout which is illustrated employs collinear reference beam illumination and diffracted data beam reconstruction, which is a layout which minimizes the required optical elements. The reference beam illumination path can also be separated from the data beam reconstruction path, which may be desired for system considerations.

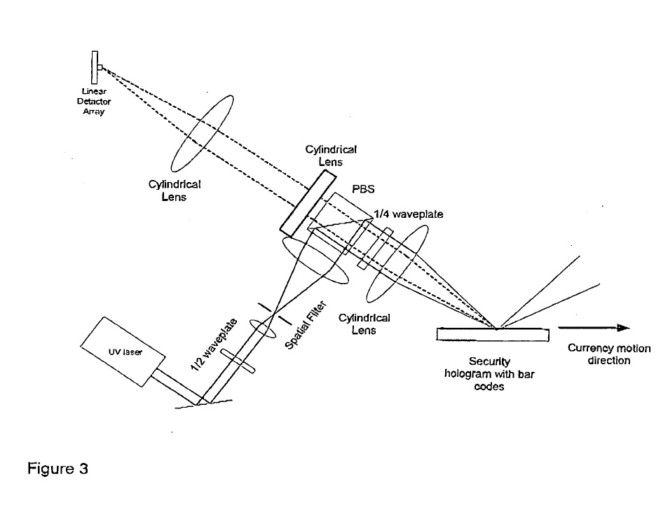

A third embodiment of a reader system for invisible data holograms is shown in FIG. 3, which shows a reader system with spherical and cylindrical optics and a 1D linear output. Because of the one-dimensional line focus illuminating the hologram and the one-dimensional line focus on the output detector array, this configuration does not have to be oriented as critically as the data page system in order to achieve focused operation upon reconstruction. The preferred embodiment for this reader system employs UV light to accomplish the readout of the hologram whose fringes have been designed to diffract only these wavelengths. This approach requires continuous or stepped motion of the input hologram past the center of the illuminating beam, and the output linear detector will sample the bar codes as they move through the illuminating beam. If magnification is desired for pixel-matching between the input and output planes, the telescope approach will be able to implement that requirement. This approach could be light efficient compared to the system illustrated in FIG. 2. The system layout which is illustrated employs collinear reference beam illumination and diffracted data beam reconstruction, which is a layout which minimizes the required optical elements. The reference beam illumination path can also be separated from the data beam reconstruction path, which may be desired for system considerations.

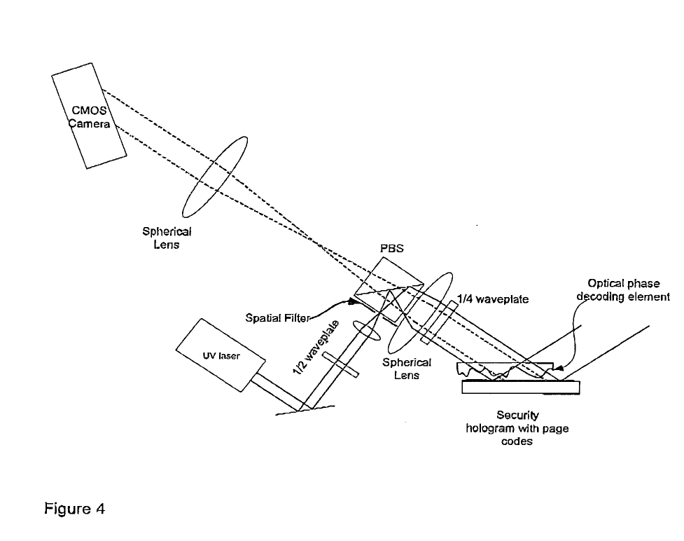

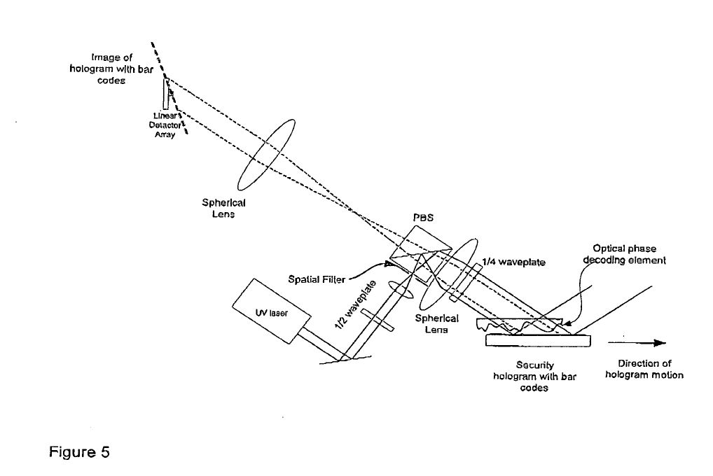

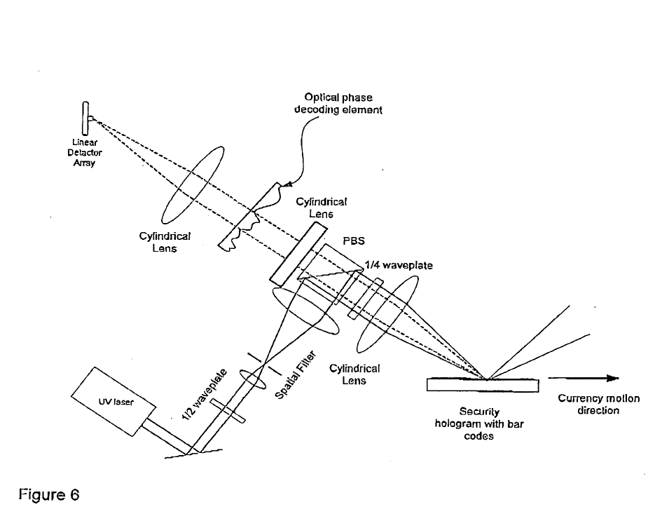

FIGS. 4, 5, and 6 illustrate optical reader systems with one embodiment each of a phase element in the reconstruction path. FIGS. 4, 5, and 6 correspond to the descriptions of FIGS. 1, 2, and 3, with the addition of the phase element in the data reconstruction path. As with the previously described optical systems, the systems in FIGS. 4, 5, and 6 are illustrated with collinear reference beam illumination and diffracted data beam reconstruction, which is a layout which minimizes the required optical elements. As with the previously described systems, the reference beam illumination path can also be separated from the data beam reconstruction path, which may be desired for system considerations.

For the high-covertness hologram configuration, a tilted-plane imaging system is desired. A single-lens imaging system produces a magnification which varies as a function of image position for a tilted plane. However, this would partially or completely defeat the ability to recall page code data, as well as create difficulty in aligning the camera to the image.

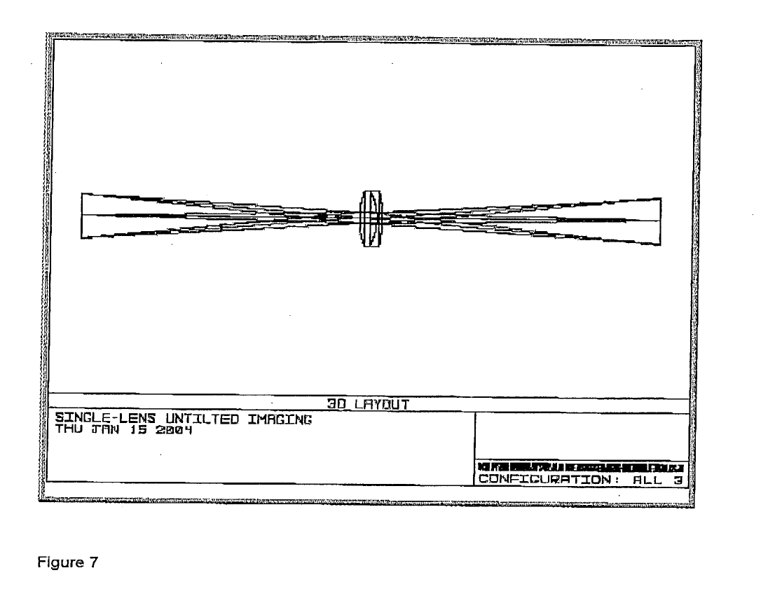

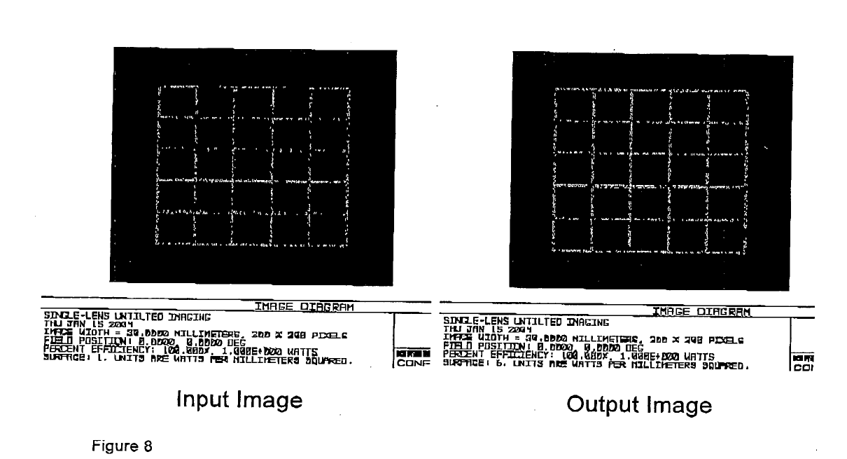

Recognizing these potential problems and further understanding tilted plane reading and imaging systems, the inventors used the Zemax ray-tracing program to model a single-lens imaging system used for parallel plane imaging wherein the object plane is parallel to the image plane as shown in FIG. 7. FIG. 8 depicts a grid input object and the resulting grid output image, demonstrating unity-magnification imaging for this case.

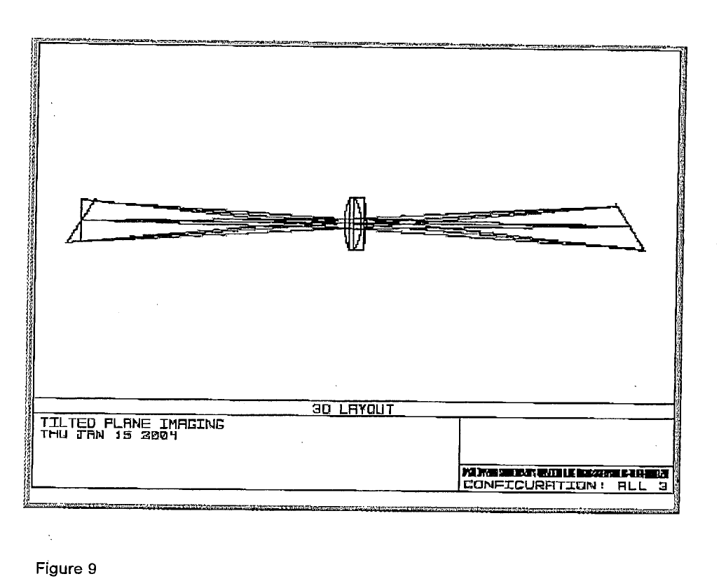

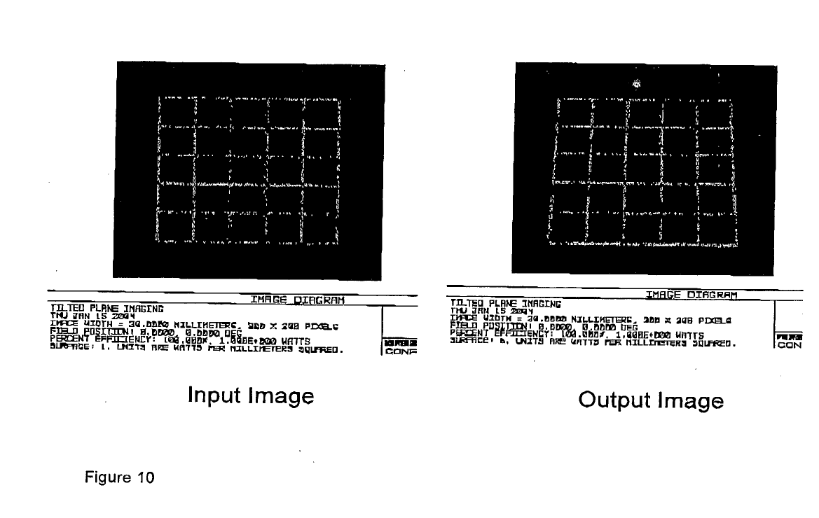

FIG. 9 illustrates the single-lens imaging system applied to the high-covertness foil image plane, in this case tilted at a 35 degree angle from the normal. The left portion of FIG. 10 shows an input grid of optical sources on the tilted object plane, a situation similar to the hologram readout situation. The right portion of FIG. 10 shows the output image of the same grid projected on a 35 degree tilted-plane, and the position-dependent magnification is apparent in the distortion of the grid in the image plane. Thus, the inventors verified by these simulations that a single-lens imaging system distorts tilted planes, and therefore generally cannot be used for two-dimensional reconstruction of the high-covertness hologram design.

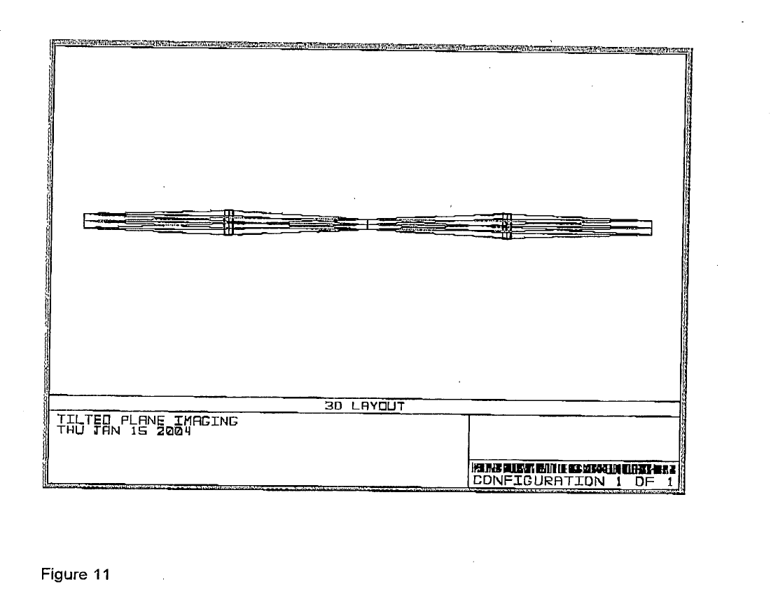

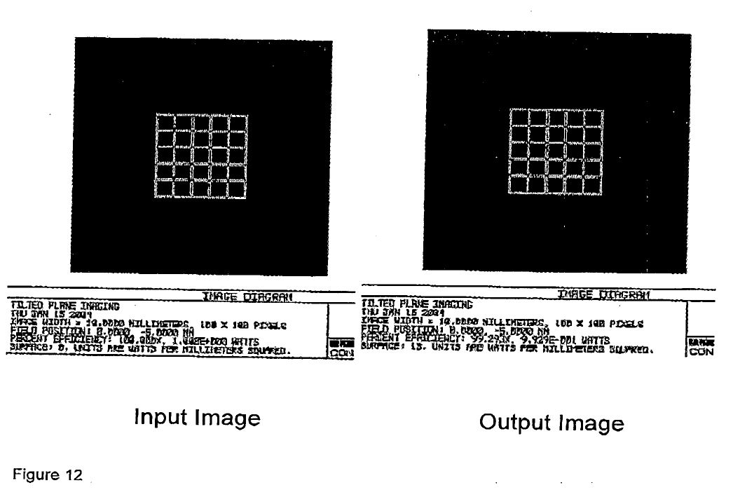

An optical system that could produce distortion-free imaging of object tilted planes onto image tilted planes could be a two-lens telescope of any magnification, Preferably, a 1:1 magnification is desired for the imaging systems of this invention. Thus, the inventors next considered a two-lens unity magnification telescope for use in a reader system. FIG. 11 shows a two-lens telescope applied to the parallel plane hologram geometry, with parallel object and image planes. The left portion of FIG. 12 shows the grid of sources on the objects, and the right portion shows the image of this grid, which is reconstructed with no magnification error.

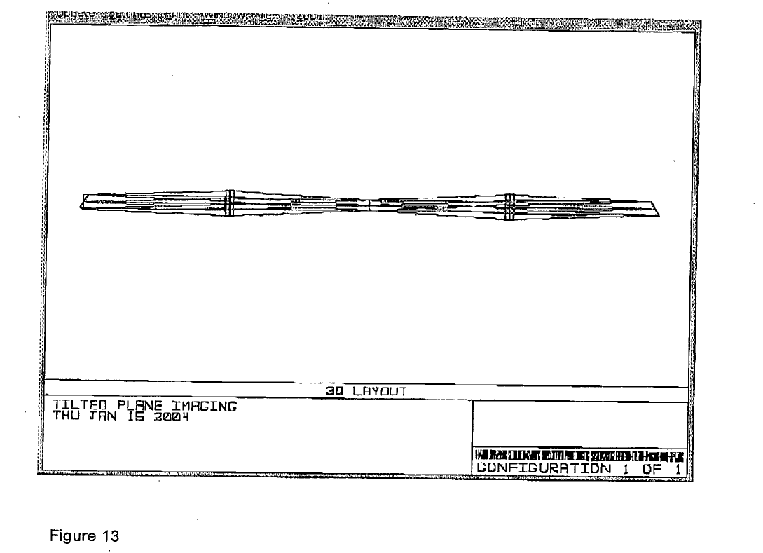

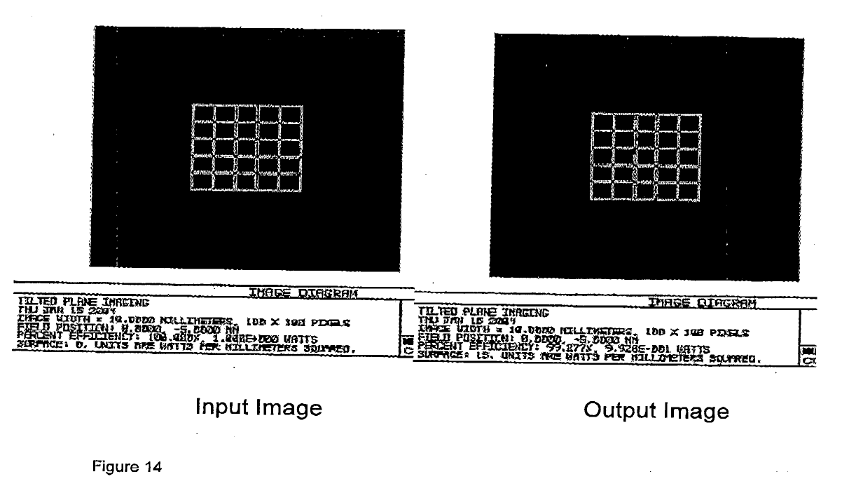

FIG. 13 shows the same two-lens telescope applied to the tilted object and image planes of the high-covertness hologram. FIG. 14 depicts the Input object and output image planes of the high-covertness data hologram, in this case successfully imaged without position-dependent magnification. This system simulation confirms that a unity-magnification two-lens telescope could image both the parallel plane and tilted plane high-covertness hologram geometries without distortions.

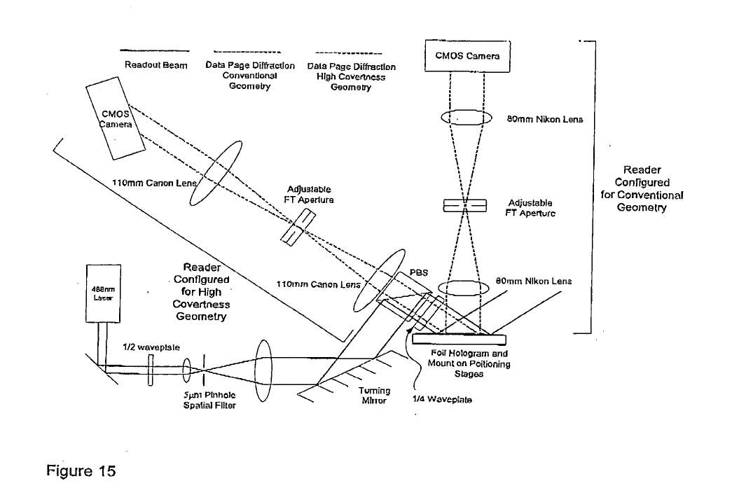

After selecting the two-lens unity-magnification telescope as the optical imaging system for the reader, the inventors prepared detailed design and the reader system was assembled on an optical breadboard, and tested the motion-control hardware and software After the reader system of FIG. 15 was assembled, and the first hologram masters arrived, the inventors tested first the parallel plane geometry, and then the tilted-plane geometry high-covertness holograms. Due to the high tilt angles required for the high-covertness holograms, the inventors used a long focal length set of lenses to prevent mechanical interferences between the telescope and the beamsplitters and/or CMOS imager. Custom software algorithms were written to control the hardware to align the camera to the data page, and Reed-Solomon error-correcting codes, which are an error-correction encoding which allows tolerance for some number of bit errors by adding information to the raw information, and then confirming that the extracted data and overhead information produce the correct verification summations, were implemented to record raw and corrected data rates from the bar code section of the data page. These are well-know approaches that were implemented to demonstrate their utility in this application.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching The embodiments were chosen and described in order to best explain the principles of the invention and its practical application, to thereby enable others skilled in the art to best utilize the invention and various embodiments with various modifications as are suited to the particular use contemplated. Many other variations are also to be considered within the scope of the present invention.

What is claimed is:

1. An article comprising a surface relief holographic recording medium comprising digital data formatted in a two-dimensional page format and recorded with a holographic fringe period that is sufficiently small such that the diffracted light from the digital data cannot be seen by human eye, wherein the holographic recording medium is a holographic material that only records surface relief holograms.

2. The article of claim 1, wherein the article is a document, a card, merchandise or a banknote.

3. The article of claim 1, wherein the holographic material that records surface relief holograms is a foil.

4. The article of claim 1, further comprising a visible image in the holographic recording medium.

5. The article of claim 4, wherein the visible image is a hologram that diffracts light that is both visible and invisible to the human eye.

6. The article of claim 1, wherein the article comprises a patch capable of being attached to a document, a card, a banknote or merchandise.

7. The article of claim 6, wherein the article further comprises a transparent protective layer overlaying the holographic recording medium.

8. The article of claim 1, wherein the digital data is machine readable holographic data.

9. The article of claim 1, wherein the holographic recording medium has multiple data sections for storing the digital data and other information.

10. The article of claim 9, wherein the other information is visible to human eye.

11. The article of claim 1, further comprising a substrate layer.

12. The article of claim 11, further comprising a laminating layer overlaying the protective layer.

13. The article of claim 1, wherein the digital data is multiplexed in substantially a same location as that of an image hologram visible to human eye.

14. The article of claim 1, wherein the digital data is patterned as a two-dimensional image.

15. The article of claim 1, wherein the digital data is a full page of digital data.

16. The article of claim 1, wherein the digital data is patterned as a series of digital data that is read by a scanner.

17. The article of claim 1, wherein the digital data are encoded to require an encoded readout beam to reconstruct the digital data.

18. The article of claim 1, wherein the digital data can only be reconstructed by UV light.

19. The article of claim 1, further comprising modulation marks for timing and/or positional servo.

20. The article of claim 1, wherein the digital data is written into the holographic recording medium before assembling components of the article into the article.

21. A method of authentication of an article of claim 1, comprising obtaining the article and reading a hologram on the article using light that is invisible to the human eye

22. The method of claim 21, wherein the digital data is arranged in a bitwise pattern for reading the digital data by a compact disk optical head.

23. The method of claim 21, wherein the beam of a two-dimensional reconstructed image is passed through an intervening optical system that is a spherical afocal telescopic system comprising a multiplicity of optical elements.

24. The method of claim 23, wherein the intervening optical system is an afocal telescopic system comprising two spherical optical lens groups, positioned physically to bring the focal positions of the two spherical optical lens groups into coincidence.

25. The method of claim 21, wherein a combination of cylindrical imaging optical elements is employed.

26. The method of claim 21, wherein a combination of cylindrical and spherical imaging optical elements are employed.

27. The method of claim 21, wherein within the tilted plane imaging system, an input image and an output image are tilted to the optical axis of the tilted plane imaging system.

28. The method of claim 27, wherein the input image and the output image are substantially distortion-free.

29. The method of claim 27, wherein a readout beam of the input image is substantially parallel to a data diffraction beam of the output image.

30. The method of claim 29, further wherein a specular reflection beam of the reconstruction beam is at an angle with respect to the data diffraction beam.

31. The method of claim 30, wherein the angle is in the range of about 20 degrees to about 160 degrees.

32. The method of claim 30, further wherein the tilted plane imaging system produces a logo diffraction beam of a logo on the article.

33. The method of claim 21, wherein the holographic recording medium is a holographic material that records surface relief holograms.

34. The method of claim 21, wherein the digital data is arranged in a pagewise fashion and the hologram is read out using a tilted-plane optical imaging system.

35. The method of claim 21, wherein the digital data is arranged as a single bar code, which is read out time-serially via a point photodetector as the hologram is passed through the optical reader system.

36. The method of claim 21, wherein the digital data is arranged as a plurality of bar codes, which are read out in parallel and time-serially via a linear array of photodetectors as the hologram is passed through the optical reader system.
